(19) United States
(12) Patent Application Publication
(10) Pub. No.: US 2006/0274461 A1
(43) Pub. Date: Dec. 7, 2006

(54) Load-guard

(76) Inventors: Jose de Jesus Ochoa, Tijiana (MX); Jorge Lopez, Tijuana BC. (MX); James Richter, Bethpage, NY (US); David Herzfeld, Huntington, NY (US); Lester Rivera, Glendale, NY (US); Roger M. Bradley, North Bellmore, NY (US); David Y. Chan, Bellerose, NY (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 11/387,808

(22) Filed: Mar. 24, 2006

Related U.S. Application Data
(60) Provisional application No. 60/668,939, filed on Apr. 6, 2005.

(51) Int. Cl. H02H 3/00

(52) U.S. Cl. 361/42

(57) ABSTRACT

A system and method for preventing miswiring of a GFCI device wherein load terminals of the GFCI device are provided with a shielding device that requires removal before the load terminals can be connected to a load. By requiring an affirmative act prior to connection of the load terminals of the GFCI to a load, miswiring of the GFCI is prevented.

Under 35 U.S.C. 119(e), this application claims the benefit of the filing date of a provisional application having Ser. No. 60/668,939 which was filed on Apr. 6, 2005.

This application includes material which is subject to copyright protection. The copyright owner has no objection to the facsimile reproduction of the patent disclosure, as it appears in the Patent and Trademark Office files or records, but otherwise reserves all rights.

### FIELD OF THE INVENTION

The present invention relates to the field of electrical connectors and Ground Fault Circuit Interrupters (GFCI's) in particular.

### BACKGROUND OF THE INVENTION

In an effort to prevent electrical shock, circuit interrupters are designed to interrupt power to various loads, such as household appliances and consumer electrical products. In particular, electrical building codes in many states require that electrical circuits in residential or commercial bathrooms and kitchens be equipped with circuit interrupters. A circuit between a power source and the receptacle exists; the circuit consists of a line (or hot) connection between the power source and the line terminal of the receptacle and a connection between the power source and the neutral terminal of the receptacle. The receptacle is thus enabled to provide power to an appliance connected thereto. When an appliance is working properly, all current that the appliance uses flows from a hot terminal of the electrical receptacle to the appliance and back, via a return path, to the neutral terminal of the receptacle. In short, the amount of current entering the appliance (from the hot or phase terminal) is equal to the amount of current leaving the appliance to the neutral terminal. When, however, a person uses an appliance in the rain or near a wet surface, an extra path may exist from the appliance through the person to ground. Thereby, an imbalance in the amount current that flows into the appliance and out of the appliance exists; that is, some of the current passing through the appliance is diverted to another path created by the person's body to ground. The imbalance between the current entering the appliance and the current leaving the appliance is referred to as a ground fault. A circuit interrupting device, such as a ground fault circuit interrupter (GFCI) located in the receptacle AC outlet or receptacle is designed to detect this current imbalance and disconnect the circuit between the receptacle and the power source so that the path from the power source to the hot terminal to the appliance back to the neutral terminal and back to the source is broken. The hot and neutral terminals of the GFCI connected directly to the power source are typically referred to as input terminals. The hot and neutral terminals connected to a load or another electrical outlet or system are usually referred to as output terminals. The output terminals are also the user accessible receptacle terminals which are used to connect electrical devices (e.g., household electrical appliances) to the GFCI receptacle.

Presently available circuit interrupter devices, such as the device described in commonly owned U.S. Pat. No. 4,595,894, use a trip mechanism to mechanically break an electrical connection between one or more input and output conductors. Such devices are resettable after the detection of a ground fault, for example. In particular, a trip mechanism is used to cause the mechanical breaking of the circuit (i.e., the connection between input and output conductors). The trip mechanism includes a solenoid (or trip coil). As a feature to test the trip mechanism and circuitry used to sense faults (i.e., fault sensing circuitry), a test button is used to initiate a test of the GFCI. When the test button is depressed, the conditions for a ground fault are caused to exist and a properly working GFCI detects the fault and is also tripped. In addition, a reset button is used to reset the electrical connection between input and output conductors after the GFCI has been tripped.

GFCIs are widely employed in both commercial and residential environments, wherein a typical GFCI incorporating a duplex receptacle provides protection for devices plugged into itself and all devices located downstream of the GFCI device.

Specifically, circuit interrupters have a line side, which is connectable to an electrical power supply, and a load side, which is connectable to one or more loads. At least one conductive path exists between the line and load sides. Where a circuit interrupting device includes a user accessible load connection, the load side connection and user accessible load connection are typically electrically connected together. Instances, however, may occur where the circuit interrupting device is improperly connected to the external wires so that the load wires are connected to the line side connection and the line wires are connected to the load connection. This is known as reverse wiring. In the event that the circuit interrupting device is reverse wired, fault protection to the user accessible load connection may be eliminated, even if fault protection to the load side connection or downstream devices remains. Thus, there is a need for electrical receptacles that are capable of detecting when reverse wiring has occurred.

Typically, and as depicted in FIG. 1, GFCIs are four terminal devices, having two hot or AC terminals 101 (only one shown) for connection to AC electrical power and two load terminals 102 (only one shown) for connection to downstream devices. Properly wired, a GFCI provides ground fault protection to downstream devices connected to its load terminals and to devices plugged into the GFCI receptacle itself. If the GFCI is reverse wired or improperly wired, the downstream devices may still be protected. The duplex receptacle, however, may not be protected if a ground fault exists. Further, since fault protection is eliminated, the load terminals or user accessible plugs will have electrical power. The user, however, may think that the device is operating properly when in fact the GFCI is not operating correctly.

In spite of detailed instructions that come packaged with most GFCIs and written identification of AC and load terminals, GFCIs are sometimes miswired. One possible reason for this miswiring is that in a new home there may not be any power coming into the distribution panel, making it difficult to identify which wires connect to AC terminals and which wires connect to load terminals. This problem is compounded when the GFCI includes a test button that trips and shuts the power off when pushed to verify operation of internal functions in the GFCI. The completed procedure concludes with the pushing of the reset button which resets the GFCI only if all portions of the GFCI are operable. Accordingly, the sole use of the test button does not indicate whether the built in duplex receptacle is protected. Typical users may not be aware of this. Users simply test the device after installation and verify that the unit trips upon pressing the test button by way of an audible click, for example, which gives the user a false sense that the GFCI is operable. Although the GFCI disconnects power and protects connected downstream loads, the receptacle contacts of the GFCI may not be protected. The device will trip depending on the condition of internal components and irrespective of how the GFCI was wired. It does not matter that the GFCI was reverse wired when it is tested. In practice, an improperly wired GFCI results in a receptacle having a powered face offering no automatic protection for any appliance that is plugged into it.

One way for a user to verify that the GFCI is properly wired is to plug an electrical device or test lamp into the receptacle contacts of a GFCI and monitor it going off and on when pressing the test followed by the reset buttons. However, this is time consuming and labor intensive. Moreover, even when explained clearly in instructions provided with the GFCI, some users do not always follow them.

Therefore, it is quite apparent that there is a strong need for a simple and effective way to ensure that a GFCI is properly wired during installation.

The present invention is directed to overcoming, or at least reducing the effects of one or more of the problems set forth above.

### SUMMARY OF THE INVENTION

To address the above-discussed deficiencies of known circuit interrupters, the present invention teaches a circuit interrupter having load terminals with physical barriers that require the physical barrier be removed prior to permitting access to the load terminals during installation of the GFCI and connection of a downstream load to the GFCI. The circuit interrupter in accordance with the present invention includes at least one pair of line terminals for connecting the circuit interrupting device to a source of electricity and at least one pair of load terminals for connecting the circuit interrupting device to a load. A removable protective barrier is attached to the circuit interrupting device, wherein the removable protective barrier is adapted to restrict access to the pair of load terminals when the removable protective barrier is attached to the circuit interrupting device. In addition, the removable protective barrier being further adapted to permit access to the load terminals when the removable protective barrier is removed from the ground fault interrupting device.

The present invention is directed to GFCI's having load terminals that require a physical barrier be removed to permit access to the load terminals during installation of the GFCI and connection of a downstream load to the GFCI. The present invention thus requires an affirmative act, i.e. the removal of the physical barrier from the load terminals, in order to accomplish connection of the load terminals to a downstream load. By requiring a deliberate act to facilitate connection of the load terminals to a load, mistakenly reverse wiring the GFCI is prevented.

In one embodiment of the invention the load terminals of the GFCI are masked by a clip-on terminal guard device that is removed just prior to connection of the load terminals, thereby eliminating the possibility of reverse wiring the load terminals.

In a second embodiment, the load terminals of a GFCI in accordance with the present invention are masked by break-off tabs that require removal before the load terminals can be connected to a load.

Advantages of this design include but are not limited to circuit interrupter having load terminals with physical barriers that employ a simple, cost-effective design.

These and other features and advantages of the present invention will be understood upon consideration of the following detailed description of the invention and the accompanying drawings.

### BRIEF DESCRIPTION OF THE DRAWINGS

For a more complete understanding of the present invention and the advantages thereof, reference is now made to the following description taken in conjunction with the accompanying drawings in which like reference numbers indicate like features and wherein:

FIG. 1 is a front perspective view of a prior art GFCI receptacle;

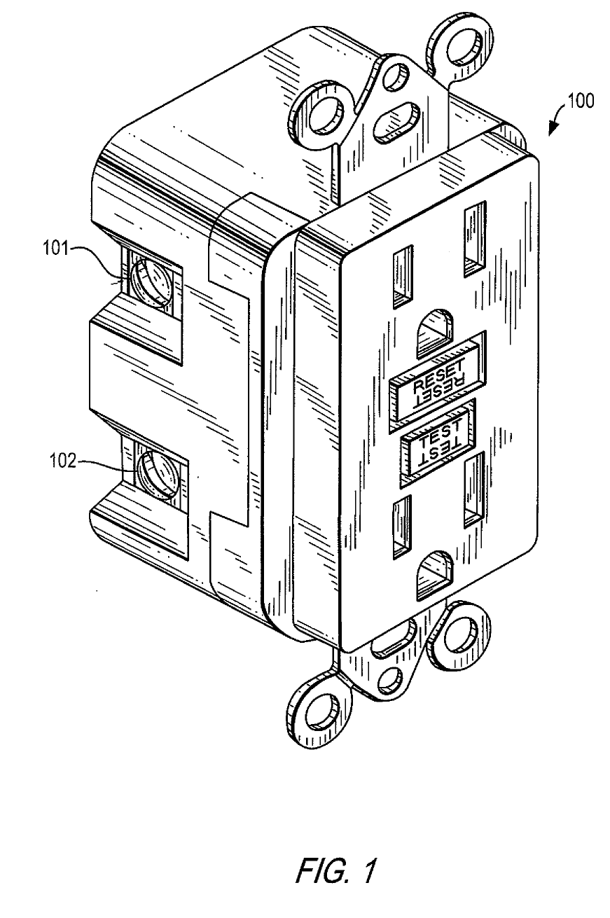

FIG. 2 is a rear perspective view of a GFCI in accordance with a first embodiment of the present invention;

FIG. 3 is shows a GFCI in accordance with a second embodiment of the present invention.

FIG. 4 shows another perspective of the first embodiment of the present invention.

FIG. 5 shows a close up view of the barrier shown in FIG. 4.

### DETAILED DESCRIPTION OF PREFERRED EMBODIMENTS

The present invention will now be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The present invention relates to a GFCI having load terminals that have obstructions which must be removed in order to connect the load terminals to a load. By requiring the deliberate act of removing the obstructions to the load terminals prior to connection to a load, unintentional reverse wiring of the GFCI terminals is prevented.

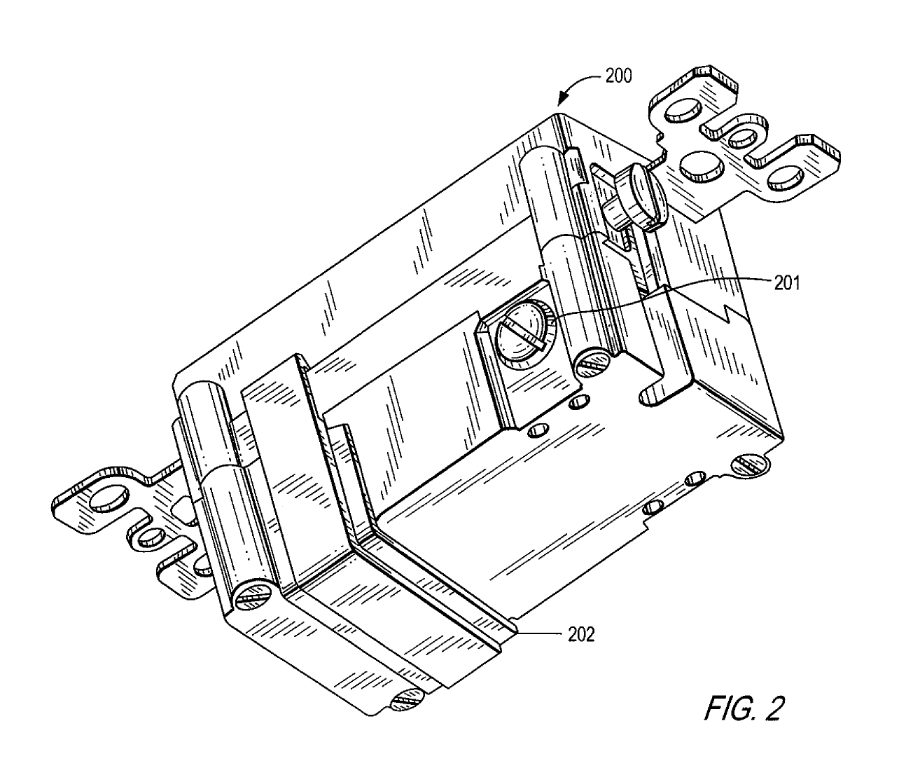

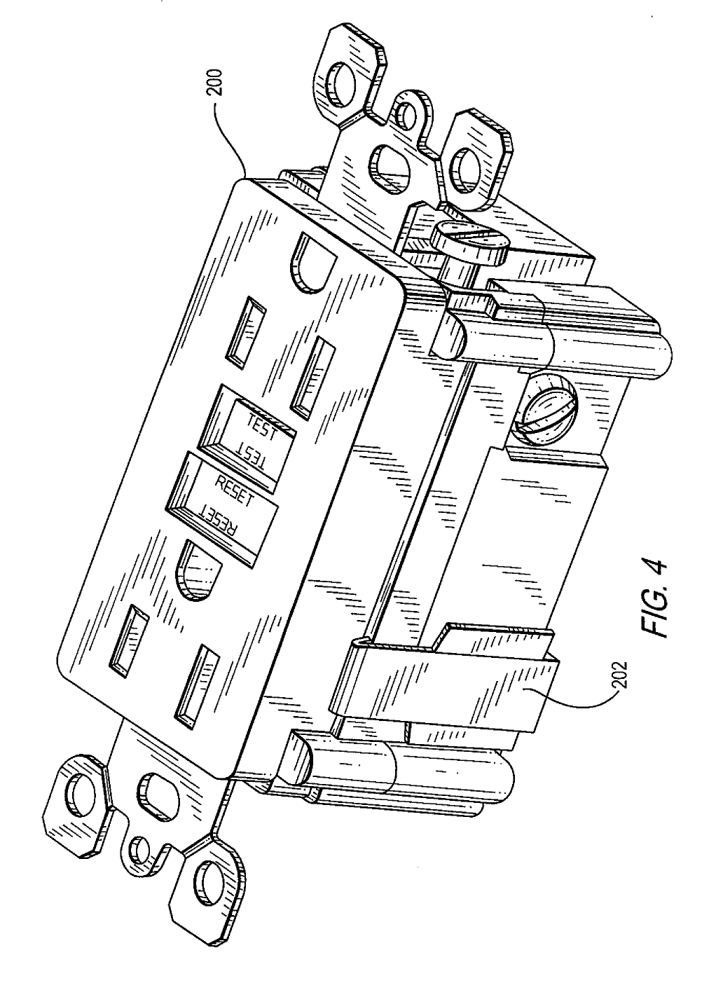

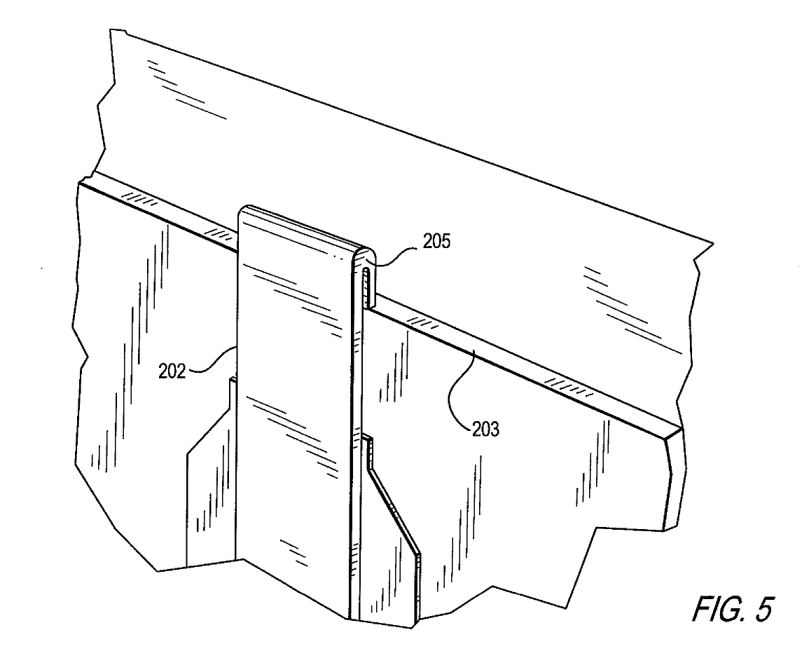

Referring now to FIG. 2, depicted therein is a GFCI 200 having a pair of line terminals 201 (only one shown) disposed at one end of the GFCI 200. A pair of load terminals are located at the other end of the GFCI 200 and are covered by removable clip 202. Removable clip 202 is removably retained such that it simultaneously obstructs both load terminals of GFCI 200. By allowing connection of load terminals 301 to a load only after clip 202 is removed, miswiring of the load terminals 301 is prevented. FIG. 4 shows how removable clip 202 is clipped onto an edge 203 of the GFCI 200. FIG. 5 is a close-up view of FIG. 4 showing removable clip 202 having a hooked end 205 part of which frictionally engages edge 203 of GFCI 200.

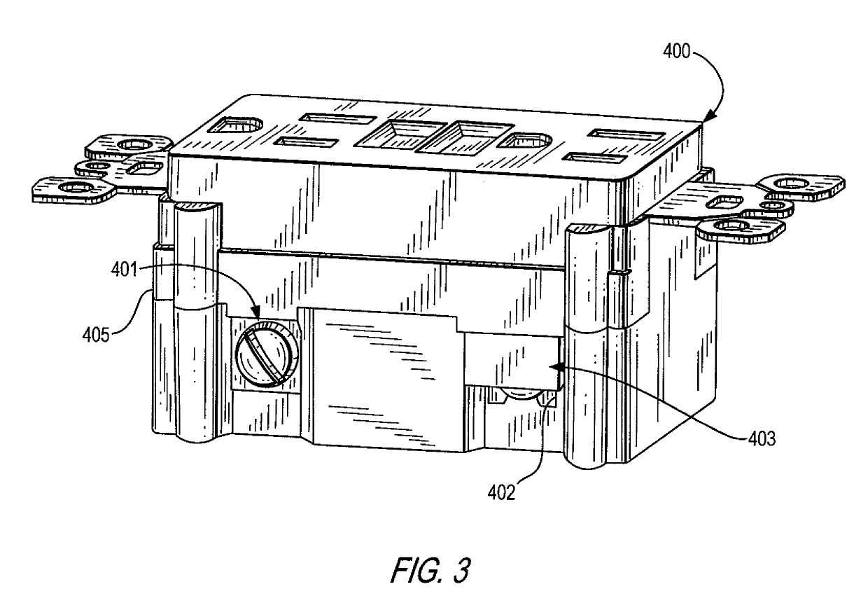

FIG. 3 shows a GFCI in accordance with a second embodiment of the present invention. As shown therein, a GFCI 400 in accordance with the present invention comprises two line terminals 401 (only one shown) and two load terminals 402 (only one shown). To prevent miswiring of the load terminals 402, the load terminals 402 are each covered by a removable tab 403 (only one shown) integral with the GFCI top housing portion 405. Tab 403 is provided such that load terminals 402 can only be can only be wired to a load after tab 403 is removed by snapping it off or bending it out of the way to fully expose load terminals 402. Thus, miswiring of load terminals 402 is prevented.

Those of skill in the art will recognize that the physical location of the elements illustrated in FIG. 2 can be moved or relocated while retaining the function described above. For example, the location and shape of the physical barrier may be changed.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

We claim:

1. A circuit interrupting device comprising:
at least one pair of line terminals for connecting the circuit interrupting device to a source of electricity;
at least one pair of load terminals for connecting the circuit interrupting device to a load; and
a removable protective barrier attached to the circuit interrupting device, the removable protective barrier adapted to restrict access to the at least one pair of load terminals when the removable protective barrier is attached to the circuit interrupting device, the removable protective barrier being further adapted to permit access to the load terminals when the removable protective barrier is removed from the circuit interrupting device.

2. A circuit interrupting device as recited in claim 1, wherein the circuit interrupting device further comprises:
a housing having a top portion coupled to a base portion, wherein the pair line terminals and the pair of load terminals extend from the base portion.

3. A circuit interrupting device as recited in claim 2, wherein the removable protective barrier comprises:
a clamp for attachment across the bottom portion to attach to the top portion of the housing of the circuit interrupting device to inhibit access to the at least one load terminals

4. A circuit interrupting device as recited in claim 1, wherein the clamp is a plastic strip.

5. A circuit interrupting device as recited in claim 1, wherein the clamp is a metal strip.

6. A circuit interrupting device as recited in claim 2, wherein the removable protective barrier comprises:
a tab coupled to the top portion of the housing that covers the at least one load terminals.
